(19) United States
(12) Patent Application Publication
(10) Pub. No.: US 2008/0221830 A1
(43) Pub. Date: Sep. 11, 2008

(54) PROBABILISTIC INFERENCE ENGINE

(75) Inventor: Hakan Mehmet Ilkin, Pittsburgh, PA (US)

Correspondence Address: K&L GATES LLP, 535 SMITHFIELD STREET, PITTSBURGH, PA, 15222, US

(73) Assignee: ENTELECHY HEALTH SYSTEMS L.L.C. C/O PERIOPTIMUM, PITTSBURGH, PA (US)

(21) Appl. No.: 12/045,538

(22) Filed: Mar. 10, 2008

Related U.S. Application Data
(60) Provisional application No. 60/906,025, filed on Mar. 9, 2007.

(51) Int. Cl. G06F 15/00

(52) U.S. Cl. 702/176

(57) ABSTRACT

A system including an inference engine and a query interface. The inference engine predicts a duration for at least one event of a perioperative workflow using one or more models. Each model includes at least one model instance. The query interface queries the at least one model instance, and the inference engine generates the predicted duration responsive to the query.

### PRIORITY CLAIM

The present application claims priority to U.S. Provisional Patent Application Ser. No. 60/906,025, filed Mar. 9, 2007, which is incorporated herein by reference.

### BACKGROUND

In a health care facility, a patient may receive diagnostic and/or therapeutic medical treatment in a number of different locations. A “health care facility” includes any medical diagnostic and/or therapeutic facility such as a hospital, clinic, or stand-alone surgery center. A health care facility may include multiple diagnostic and/or therapeutic departments through which the progress of a patient may be tracked during a patient workflow process. The systematic process of a patient moving to different locations or departments within the health care facility to receive medical treatment is referred to as a patient workflow process. The diagnostic and/or therapeutic departments of a health care facility may include, for example, radiology, oncology, catheterization, emergency, and/or surgical departments. The workflow process for a patient scheduled for surgery may be referred to as a perioperative process. A “perioperative” process includes the (1) preoperative, (2) intraoperative, and (3) postoperative phases of surgery. A perioperative process may include an anesthesia workflow process. During the perioperative process, information about a patient's progress typically may be obtained by limited mechanisms such as inquiries made to the health care facility staff. Herein, the term “staff” refers to doctors, surgeons, anesthesiologists, nurses, and any other person responsible at some level for providing patient care.

As the patient advances through the workflow process, there is a need to track the progress of the patient. Tracking the progress of the patient, however, may be difficult for the hospital staff. Staff members must monitor the patient using a combination of verbal communications via telephone calls and in-person conversations, and personal observations. However, it may be difficult for health care facility staff to obtain that information. Consequently, the staff can become embroiled in the task of chasing down information concerning the patient progress causing delays in communication, which can translate directly to delays in patient care. This also may result in neglect of other duties.

In addition, the staff also must contend with the manner in which changes in patient treatment schedules affect the workflow process. Should there be a deviation from or change in the workflow process schedule of any patient, the staff must be made aware of such changes in order to alter their activities accordingly. In such instances, the staff members are faced with the similar information-gathering difficulties as previously discussed. These difficulties can result in the staff falling further behind schedule and cause further delays in patient care.

Decision support in the perioperative workflow often relies on the analysis of the operational data. Various forms of data analysis can underlie the duration estimation for timely initiations and execution of numerous tasks and procedures. The estimations in the clinical workflow demand highly flexible models due to the nature of the criteria necessary to represent the problem context in the real world.

Specifically, the interval definitions as well as the intervals of interest can vary per workflow. The conditions driving the estimation, i.e., predictive criteria, vary per perioperative workflow. The facility or site may be a critical factor in predicting interval durations for a multi-facility setting yet may be ignored for others. Workflow implementations can rely on multiple models varying in their definition or prioritization of the predictive criteria. These models can support different views of those involved in the decision-making process. The relationship between the estimated duration and the predictive criteria is often unknown or does not lend itself to an approximation by a linear model and hence requires a non-linear, non-parametric type of regression fitting approach. The predictive criteria in these estimations make wide use of categorical variables (surgeon, surgical procedure). Hence the suggested estimation process is mostly categorical (discriminant analysis or classification). However, the criteria are not limited to such classifications. For instance, staffing levels and resource availability can be represented by continuous variables (nonparametric regression). Such estimations, therefore, require an inference engine and models that allow for both continuous and discrete (categorical) variables. The data necessary to define the real-world problem context may not be available when an estimate is required. This would necessitate an inference engine that could handle incomplete definition of predictive criteria for duration estimations. It is important to track and expose the match strength as it affects the likelihood of the estimate (probability coefficient). Not all predictive criteria have the same strength in grouping event data, requiring a prioritization of the predictive criteria through weight assignments. Such prioritization could in turn affect the decision tree structuring and the likelihood (or probability coefficient) during retrieval. These weights should be re-adjusted through a feedback mechanism that involves the analysis of event distributions at the decision tree leaves.

Thus, there is a need for a probabilistic inference engine (ProbIE) to estimate duration incorporating a repository of events that are structured around a configurable set of predictive criteria (variables).

### SUMMARY

In one general respect, the present application is directed to a system including an inference engine and a query interface. The inference engine predicts a duration for at least one event of a perioperative workflow using one or more models. Each model includes at least one model instance. The query interface queries the at least one model instance, and the inference engine generates the predicted duration responsive to the query.

### BRIEF DESCRIPTION OF THE DRAWINGS

FIG. 1 illustrates one embodiment of a patient workflow process system comprising a patient workflow management (PWM) system.

FIG. 2 illustrates one embodiment of a PWM system.

FIG. 3 illustrates one embodiment of a probabilistic inference engine (ProbIE) system.

FIG. 4A is a diagram illustrating the stages of one embodiment of a perioperative workflow process for an ambulatory patient.

FIG. 4B is a diagram illustrating the stages of one embodiment of a perioperative workflow process for an inpatient.

### DESCRIPTION

The various embodiments described herein are directed generally to apparatuses, systems, and methods for distributing information associated with a patient workflow process in a health care facility. As previously discussed, a workflow process includes the systematic process of a patient moving to different locations or departments within the health care facility to receive medical treatment, including, for example, a perioperative process. As previously discussed, a health care facility includes any hospital, clinic, stand-alone surgery center, or any medical facility that provides medical diagnostic and/or therapeutic treatment services. A health care facility may comprise multiple diagnostic and/or therapeutic departments, such as radiology, oncology, catheterization, emergency, and/or surgical departments, located throughout the health care facility. There is a need to track the progress of a patient through the workflow process in any of these departments. To determine or track the progress of the patient in the workflow process, the location information needs to be known with suitable accuracy. Accordingly, various embodiments of a tracking system described herein are directed to tracking and/or distributing information associated with the progress of a patient advancing through a workflow process. For example, during a perioperative workflow process, the location of a patient may be tracked during the preoperative, intraoperative, and postoperative phases of surgery. Thus, to determine or track the progress of the patient through the perioperative workflow process, the location of the patient in the perioperative workflow process should be tracked with suitable accuracy.

In addition, various embodiments described herein are directed to apparatuses, systems, and methods for distributing messages concerning the progress of a patient through a patient workflow process to people having an association with, interest in, caring for, or relationship with the patient. Patient progress information may comprise physical or logical location or position information associated with the patient in any workflow process in the health care facility. For convenience and clarity, any person associated with, interested in, caring for, or having a relationship with the patient may be referred to herein as a “stakeholder.” For example, the term stakeholder may refer to the patient family members and/or the hospital staff. It is to be understood, however, that as used herein, the term “family” is intended to encompass more than just the traditional family members of the patient and comprises friends, relatives, guardians or any person designated by the patient or legal authority as having an association with, any interest in, or any relationship with the patient. Furthermore, as used herein, the term “staff” refers to doctors, surgeons, anesthesiologists, nurses, and any other person responsible at some level for providing patient care. The embodiments, however, are not limited in this context.

When the patient progress information associated with a perioperative process is received by a centralized computer system, the information may be distributed to the health care facility staff and the patient family members as described in various embodiments herein. In accordance with these embodiments, information associated with the state of the patient progress through the perioperative process is collected and processed. Such data can be collected through one or more methods. For example, the data may be entered manually through a workstation coupled to a computer system by a local area network. In addition, the data also may be entered automatically into the system by one or more techniques, such as reading the location of a patient from a patient locator badge and a RTLS. In one embodiment, a RTLS may comprise RFID technology wherein the patient is provided with an RFID tag that can be read and monitored by an RFID-tracking system, for example. The embodiments, however, are not limited in this context.

A computer system may be implemented as a server to receive the patient workflow process information or data from any source. The computer system may have knowledge of a proposed course of diagnostic and/or therapeutic treatment for the patient in any department of the health care facility, as well as the steps and processes which are implicated by that course of treatment. The computer system may comprise a component or module that determines the accuracy of incoming RTLS patient location information.

A process in accordance with various embodiments may comprise one or more computer systems receiving user input through a graphical user interface (GUI). This user interface may be a program which is executed on a workstation coupled to the computer system through a network, such as, for example, a local area network (LAN), available to the staff and/or the family members. The user interface may be configured to receive data from either the staff or the family members which the system will use to determine which events during the patient workflow process may trigger a correction to the RTLS information.

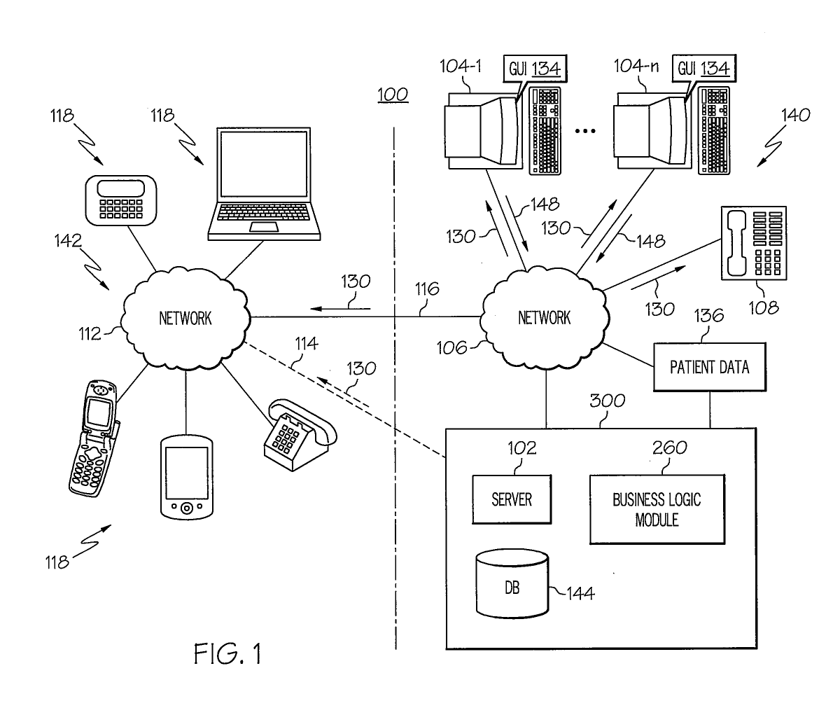

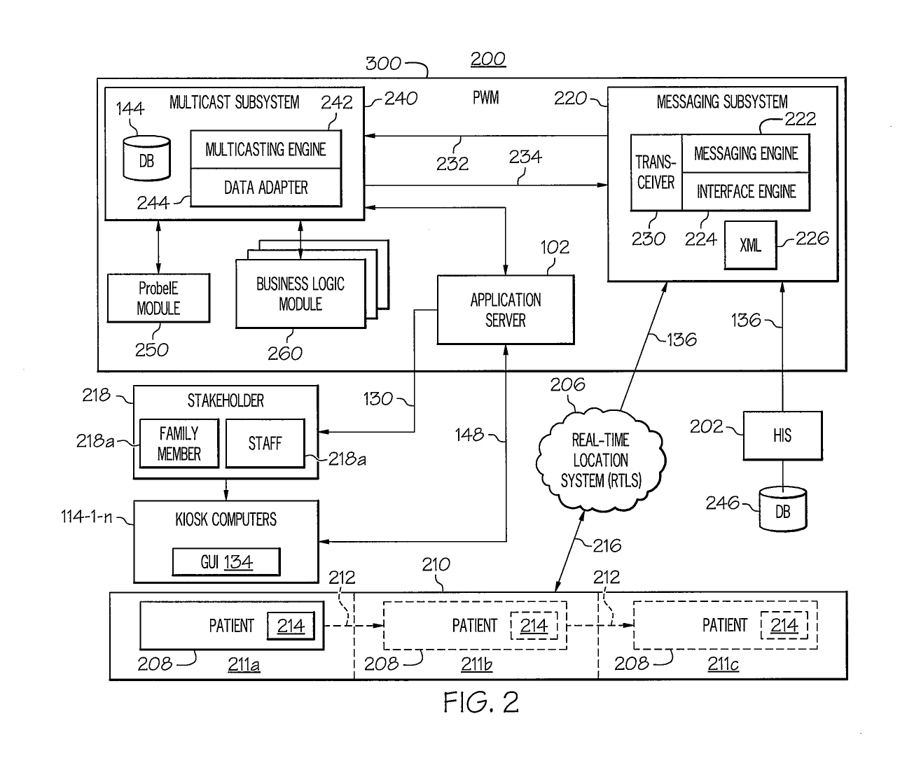

FIG. 1 illustrates one embodiment of a patient workflow management (PWM) 300 within the context of the health care facility communication infrastructure. The PWM system 300 may be adapted and configured to receive patient workflow process information or data 136 (“patient information” hereinafter) from a variety of sources. The patient information 136 may be received from a hospital information system 202 (HIS) (FIG. 2), a real-time location system 206 (RTLS) (FIG. 2), which could be a RFID tracking system, for example. In one implementation, the patient information 136 may be provided substantially on a real-time basis and may be stored in a database 144. In general, the patient information 136 comprises the state of the patient through the patient workflow process. As previously discussed, the patient workflow process refers to the progress of a patient in any health care facility diagnostic and/or therapeutic process in any one of a radiology, oncology, catheterization, emergency, and/or surgical department. The patient information 136 refers to any information associated with any of these processes. During a workflow process, a patient may be transferred through any one or more of these departments to receive medical diagnostic and/or therapeutic treatments in the health care facility. In one embodiment, the content of the patient information 136 may be configurable. For example, the content of the patient information 136 may be configured to include/exclude: (1) Patient Name; (2) Care Provider; (3) Patient Location; (4) Health care Facility Site; (5) Location Group; (6) Case Information; (7) Clinical Information; (8) Event Information; and/or (9) Event Time. The patient information 136 may comprise the status of the patient, the condition of the patient, and/or the progress of the patient through the workflow process (described in more detail below in the context of a perioperative workflow). In one embodiment, the patient information 136 also may comprise the badge identification number, sensor or tag identification number, time, and type of movement.

The PWM system 300 comprises an application server 102 coupled to one or more computers 104-1-n, where n is any positive integer. The computers 104-1-n may comprise special single function computers, workstations, large screen displays, and kiosks, for example, and any other communication devices and/or media. The computers 104-1-n may comprise a display device, such as a liquid crystal display (LCD), plasma, thin film transistor (TFT), or cathode ray tube (CRT) monitor, a device for user input, such as a keyboard or mouse, a processor, an application component, and memory for receiving and processing entered information. The computers 104-1-n may be implemented as kiosks and may be made available to patient family members at various locations throughout a health care facility.

The PWM system 300 may be coupled to the computers 104-1-n over a first network 106. The first network 106 may be internal to the health care facility, such as a local area network (LAN), PBX system, and the like. The network 106 also may comprise internal networks, such as the HIS 202 and the RTLS 206 shown in FIG. 2. The PWM system 300 also may be coupled to a telephone system 108 either directly or via the first network 106. The PWM system 300 may include components, such as business logic module 260, to increase the accuracy of the RTLS 206.

The PWM system 300 may be coupled to a second network 112 by way of a first connection 114. The PWM system 300 also may be coupled to the second network 112 by way of the first network 106 over a second connection 116, for example. The PWM system 300 can support virtually any computer or telecommunication mechanisms for communication. In one embodiment, the PWM system 300 may be implemented to use communication mechanisms that may be currently common within health care facility and consumer domains. Accordingly, the second network 112 may provide the PWM system 300 with access to a variety of communications devices 118. The communications devices 118 may comprise, for example, a laptop or other computer, a pager, a cell phone or smart phone, a personal digital assistant (PDA), or a landline telephone. Although the first and second networks 108, 112, respectively, are shown as separate networks, those skilled in the art will appreciate that the networks 108, 112 may be combined as a single network or may be expanded to multiple networks without limitation.

The PWM 300 tracks patients, resources, or entities located in a health care facility. The patients, resources, or entities may be located in an operating room (OR), stand-alone surgical center, oncology, radiology, catheterization, emergency, and/or a surgical department, among other departments of the health care facility. The PWM 300 tracks and stores information of specific, predetermined milestones associated with the patient progress through the workflow process. Software modules executed by the application server 102 may be configured to store the real-time patient information 136 about the status of the patient in the database 144 and to generate the messages 130 in accordance with the patient information 136. Based on the predetermined milestones (e.g., surgery begins, patient enters postoperative room, patient gets discharged may be considered milestones in a perioperative workflow process, among others), the system progresses the patient through the perioperative process.

The PWM system 300 knows the intended diagnostic and/or therapeutic treatment flow of a patient through the patient workflow process and the location of patient within that process. For the purposes of the following description, this knowledge may be assumed to be known or may be obtained by the PWM system 300 on a real-time basis. The PWM system 300 employs an active form of communication to make this information available. In one embodiment, the PWM system 300 enables the active form of communication by formatting the message 130 for the distributed information and allowing the family members to be alerted or receive the message 130 “on-demand.”

The PWM system 300 may be integrated or operate in conjunction with other systems for tracking patients throughout the patient workflow process, including communicating with external systems 142, communicating real-time data within internal systems 140, and incorporating a repository of events that are structured around a configurable set of predictive criteria (variables). Herein, the term internal systems 140 is used to refer to communication and processing systems that may pertain to a health care facility regardless of whether these systems are present in the same location. The term external systems 142 is used to refer to communication and processing systems that are not specific to the health care facility even if they may be located or accessible within the health care facility.

FIG. 2 illustrates one embodiment of a perioperative system 200. The perioperative system 200 may be associated with the surgical process in a surgical department of a health care facility. The perioperative system 200 may comprise one embodiment of the patient workflow process PWM 300 illustrated in FIG. 1 that is directed specifically to the perioperative process, although the embodiments are not limited in this context. In the illustrated embodiment, the perioperative system 200 is integrated with the PWM system 300, the HIS 202, and the RTLS 206. Although the perioperative system 200 is described as comprising one embodiment of a correction module to correct RTLS information, other embodiments of the perioperative system 200 may be implemented for any patient workflow processes associated with any health care facility diagnostic and/or therapeutic process in a radiology, oncology, catheterization, and/or emergency department.

In one embodiment, the RTLS 206 may be employed to track a patient 208 throughout a perioperative workflow process 210 using RTLS tags 214 located on the patient 208 or in proximity to the patient 208, or a locator badge dispensed to the patient 208 at check-in time. In one embodiment, the locator badge also may comprise the RTLS tags 214. The RTLS tags 214 and the locator badge may operatively interact with the RTLS 206. Herein, tracking the patient 208 throughout the perioperative workflow process 210 may include tracking the patient 208 through a preoperative workflow process 211a, an intraoperative workflow process 211b, and/or a postoperative workflow process 211c. The RTLS 206 captures real-time patient location data 216 and provides that data to the PWM system 300 to determine when the patient 208 transitions 212 from one location to another or from one process to another (211a→211b→211c). The location data 216 is associated with events to determine the location of the patient 208 in the perioperative workflow process 210 (or anesthesia pathways). Consequently, the gathered real-time location data 216 is provided to the PWM system 300 in the form of the patient information 136, which may be received by the PWM system 300 from the HIS 202 and/or the RTLS 206. As previously discussed, the location data 216, and, thus, the patient information 136, may include errors as to the exact location of the patient 208 in the perioperative workflow process 210 at any given time.

The PWM system 300 sends messages 130 to the stakeholders 218 based on the patient information 136 and the notification configuration message 148 submitted to the PWM system 300 by the stakeholders 218 (e.g., patient family members 218a and health care facility staff 218b). Herein, the patient family member stakeholders are referred to as family members 218a and the health care facility staff stakeholders are referred to as staff 218b. As previously discussed, the stakeholders 218 may receive the messages 130 in accordance with preferences they entered in the computers 104-1-n via the notification GUI 134. In a similar manner, the stakeholders 218 also may select the content of the messages 130 among other predetermined criteria via the notification GUI 134. In one embodiment, the PWM system 300 provides real-time visualization capabilities for the OR managers to make timely decisions regarding resource usage across multiple facilities.

The PWM system 300 receives and processes the real-time patient location data 216 received from RTLS 206 tags 214 dispensed to the individual patients 208 in the form of patient information 136. By processing the real-time patient information 136 comprising the location data 216 received from the RTLS tags 214, the PWM system 300 can determine when the patient 208 transitions 212 from one location to another within the health care facility during the perioperative workflow process 210. The real-time location data 216 from the RTLS 206 comprises information related the transitions 212 or movements of the patient 208 from one location to another during any phase of the perioperative workflow process 210 within a health care facility. The PWM system 300 may subsequently associate the real-time location data 216 with information related to the intended perioperative treatment for the patient 208 to determine the location of the patient 208 in the perioperative workflow process 210. This information may be stored and processed by the PWM system 300 after any necessary corrections are applied to the location data 216 or patient information 136. The PWM system 300 then transmits the messages 130 to the stakeholders 218 concerning the status and/or progress of the patient 208 in the perioperative workflow 210 process.

When the patient 208 workflow process information 136 (e.g., patient data) is received by the PWM system 300, the information 136 may be distributed to the stakeholders 218, e.g., the patient family 218a and/or the staff 218b members, after the necessary corrections are made to the patient information 136 as described in various embodiments herein. In accordance with these embodiments, the location data 216 associated with the patient 208 progress through the workflow process 210 may be collected and processed by a RTLS 206. This information can be collected through one or more methods. For example, the information may be entered manually through a workstation coupled to a computer system by a local area network. In addition, the information may be entered automatically into the PWM system 300 by one or more techniques, including reading the location of the patient 208 from the patient locator badge 214 or determining the location of the patient 208 with the RTLS 206. One such real-time location system may comprise RFID technology. In such an RFID-based system, the patient 208 is provided with an RFID tag 214 that can be read and monitored by an RFID tracking system such as the RTLS 206. The embodiments, however, are not limited in this context.

Various embodiments of a patient tracking system or the PWM system 300 may comprise a RTLS 206 based on RFID technology and one or more modules to improve the accuracy of the patient location data 216 in accordance with the techniques described herein. The RTLS 206 based on RFID technology may be employed for tracking persons such as the patients 208 as well as the staff, and/or any other resources or entities within the health care facility. In one embodiment, the PWM system 300 may comprise a correction module to reduce errors in the location information produced by or associated with the RTLS 206. Thus, the patient 208 location data 216 or any information associated with a resource or other health care facility entities may be determined with far greater accuracy than with the RTLS 206.

When the patient 208 arrives at a health care facility for a procedure, the procedure time is either scheduled before the arrival or, in emergency cases, upon the arrival. When the patient 208 is scheduled for the procedure, information about the patient 208, the care provider, and the procedure are determined by the staff 218b. This patient information, along with the proposed start time and duration of the scheduled procedure, are entered into a patient data database 246. The database 246 may be present either in the HIS 202 or in a similar system that stores and processes patient information, such as the scheduled procedure and duration time of the procedure.

The PWM system 300 also may contain a messaging subsystem 220. The messaging subsystem 220 may comprise a messaging engine 222 to provide an extensible, configurable framework for communicating with the internal 140 or the external 142 systems (FIG. 1). The messaging engine 222 may comprise an interface engine 224, XML streams 226, etc. Communication may be handled by one or more “transceivers” 230 that transmit messaging data 232 from the messaging engine 222 to a subsystem of the PWM system 300 and receive and provide messaging data 234 from a subsystem of the PWM system 300 to the messaging engine 222. The transceivers 230 convert outgoing internal data 232 into an external protocol specific for the purpose of each of the transceivers 230. Several transceivers 230 may be distributed throughout the messaging subsystem 220. The transceivers 230 may plug into the framework of the PWM system 300.

The PWM system 300 may comprise a multicast subsystem 240 coupled to the application server 102. The multicast subsystem 240 may comprise a multicast engine 242 to provide an extensible, configurable framework for real-time data communication among any of the communication components or elements of the internal system 140 (FIG. 1). The architecture, however, also may provide external applications to plug into the multicast subsystem 240. The architecture may be implemented as a publish/subscribe model which also enables querying. Because the multicast subsystem 240 is responsible for persisting published data, as well as querying persisted data, a portion of its architecture may lie in one or more “data adapters” 244 which plug into the multicast engine 242 in a configurable fashion to facilitate persistence and retrieval of data to the one or more databases 144 (e.g., SQL databases), etc. The data adapters 244 may be provided to operate in conjunction with the multicast subsystem 240 to provide default persistence and retrieve all data supported for communication via the multicasting engine 242. The architecture may provide for the use of custom data adapters 244 to perform custom persistence and/or retrieval functionality. The multicast subsystem 240 may be coupled to a business logic module 260 and a probabilistic inference engine module 250 (described in more below). In one implementation, the business logic module 260 may comprises a component to validate the changes in the location of the patient 208.

The PWM system 300 may comprise or may be integrated or operate in conjunction with a probabilistic inference engine module 250 (ProbIE). The duration specific information of the message 130 may be incorporated through the ProbIE module 250. The ProbIE module 250 may be is built-in to the PWM system 300 and provides duration estimations based on real-time contextual information. The ProbIE module 250 provides duration estimation incorporating a repository of events that are structured around a configurable set of predictive criteria (variables). These repositories may be implemented as model instances that evolve in time, i.e., the models may be re-structured when new event information is introduced to the PWM system 300. The ProbIE module 250 provides a query interface for retrieving estimated durations. The queries may contain incomplete (i.e., partially matching) criteria defining the event context for the interval of interest. When there is no exact match between the predictive criteria indexing events in the repository and the real-time criteria, the ProbIE module 250 will return the estimate for the best possible match along with an indicator that represents the “likelihood” for the estimation. The PWM system 300 also may employ the ProbIE module 250 to provide the staff 218b with estimated duration information that is specific to the procedure and the staff 218b performing the procedure.

In one embodiment, the RTLS 206 may be employed in location information systems related to patient care and, more particularly, to distributing messages concerning the progress of the patient 208 through the workflow process 210 (e.g., the perioperative process) to people having an association with, interest in, or relationship with the patient 208 and to the health care staff 218b. For convenience and clarity, any person having an association with, interest in, or relationship with the patient may be referred to herein as the stakeholder 218 and may comprise the patient family 218a or the staff 218b. It is to be understood, however, that the scope of the term “family” is intended to encompass more than just the traditional family members of the patient 208 and comprises friends, relatives, guardians or any person designated by the patient 208 or legal authority having an association with, interest in, or relationship with the patient 208. The embodiments, therefore, are not limited in the context of a traditional family.

The following description of the PWM system 300 functionality is with respect to the stakeholders 218 grouped under the “Patient Family” 218a category. The patient 208 is often accompanied by one or more family members 218a. These family members 218a may wait in the waiting room, move to another area of the health care facility (e.g., a cafeteria) or leave altogether. When the patient 208 arrives at the health care facility for a surgical procedure, the patient 208 is either scheduled a priori to their arrival or will be scheduled upon their arrival (e.g., emergency cases). At the time of scheduling, the information pertaining to the patient 208, the health care provider, and the procedures are persisted along with the projected start times. These reservations may be processed by the HIS 202. When the patient 208 signs into the health care facility, they receive a badge (which may comprise an RTLS tag 214) that allows them to be recognized by the RTLS 206. The RTLS 206 tracks the patient 208 through the perioperative workflow process 210. In a broader sense, the RTLS 206 may be adapted to track the patient 208 throughout any patient workflow processes.

After the patient 208 arrives at the health care facility, the patient 208 is tracked through the workflow process 210 by both receiving movement indications in the form location data 216 from the RTLS 206 and also other staff interactions with the GUI 134 of the PWM 300. TABLE 1 provides a list of example milestones during the perioperative workflow process 210 that may be tracked by the hospital. The choice of milestones may differ across procedures and health care facilities.

TABLE 1
Patient Milestones

| | |
|---|---|
| 1. | Patient Signed in |
| 2. | Patient Ready for transport |
| 3. | Patient Sent for |
| 4. | Patient Available |
| 5. | Patient in Pre-op |
| 6. | Anesthesia interview started |
| 7. | Anesthesia interview completed |
| 8. | Anesthesia started |
| 9. | Patient in procedure room |
| 10. | Physician in room |
| 11. | Procedure begins |
| 12. | Procedure ends |
| 13. | Patient out of procedure room |
| 14. | Patient in post-anesthesia care unit (PACU) |
| 15. | Anesthesia finished |
| 16. | Patient moved to Post-op |
| 17. | Patient family interview |
| 18. | Patient ready for discharge |

The milestones listed in TABLE 1 are provided merely as an example of what the health care facility may track. These milestones may differ based on the procedures and the health care facility and, therefore, they are not exhaustive examples of milestones. Therefore, the embodiments discussed herein are not limited in this context.

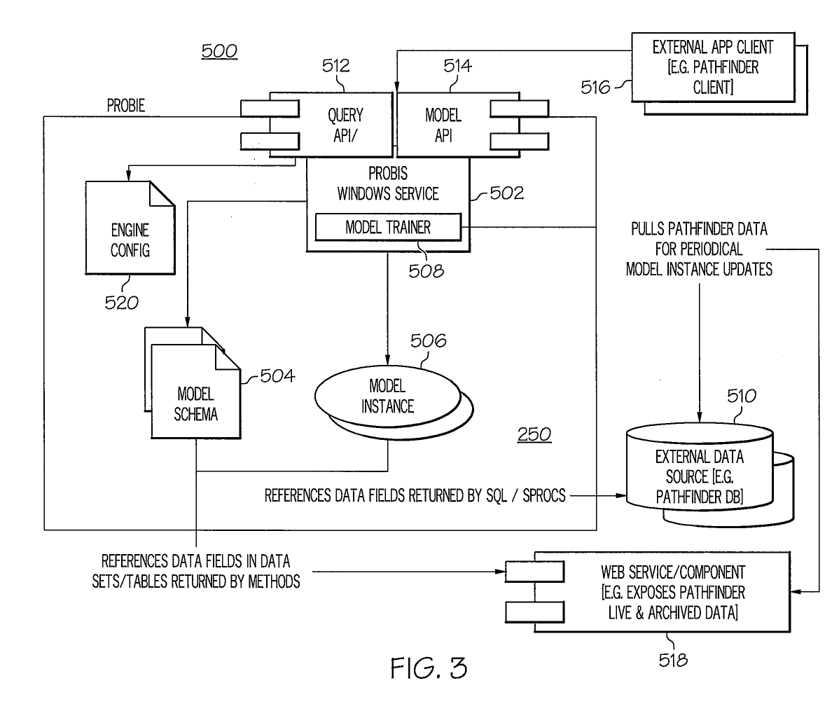

FIG. 3 illustrates one embodiment of a probabilistic inference engine (ProbIE) system 500. The system comprises one embodiment of the ProbIE module 250 illustrated in FIG. 2. The ProbIE module 250 comprises a probabilistic inference server module 502 (ProbIS) at its core to access models for various management functions and queries. In the illustrated embodiment, the ProbIS module 502 comprises a service application such as a Windows Service application, for example. The ProbIS module 502 maintains a repository of models and corresponding model update processes. As used herein, a model may be an abstraction or construct that represents an event with a set of variables or predictive criteria and a set of logical and quantitative relationships between them. Models may be constructed to enable reasoning within the logical framework of the ProbIE module 250. The model may employ explicit assumptions that are known to be false (or may be incomplete) in some detail. These assumptions may be acceptable because they simplify the model while, at the same time, they allow the production of acceptably accurate solutions, as described below.

In one embodiment, the ProbIE module 250 may provide access to and maintain numerous models that potentially may facilitate versioning, for example. Each model may comprise a model schema 504 to provide the definitions for the predictive variables and the measures of interest, and a number of corresponding model instances 506 (versions) incorporating a forest of events structured around predictive variables identified in the model schema 504. The model schema 504, which may be persisted as XML, comprises the element definitions on which the ProbIE module 250 operates along with bindings to schema elements from mapped external data sources 510. The model instance 506, which may be persisted as a binary, is an actual instance of the inference model that encapsulates historical data. More than one instance may be persisted by the model.

The ProbIS 502 may comprise a model trainer 508 component to train the ProbIE module 250 models based on new information received by the system 500. Addition of new events to decision trees such as regression and classification trees may create new nodes, split, or prune branches if necessary. The model trainer 508 component may be a portion of the ProbIS 502, encapsulating a process that runs periodically to perform data acquisition and the corresponding model updates.

A decision tree is a predictive model and may be defined as a mapping of observations about an item to conclusions about the target value of the item. The decision tree may comprise interior nodes wherein each interior node corresponds to a variable. An arc to a child represents a possible value of that variable. A leaf represents the predicted value of a target variable given the values of the variables represented by the path from the root. A dynamic schema may be implemented for the predictive model where the independent variable definitions can be changed by an analyst. There may be a non-linear relation between the dependent and independent variables.

The model trainer 508 component employs a binding component to acquire event data from the external data source 510 or from an external application framework 516. As the model schema 504 can often change in terms of predictive criteria definitions, the model instances 506 and the external data source 510 may be loosely coupled, i.e., client application specific data binding between the external data source 510 and the model elements should not be hard coded by the model trainer 508 component. The binding component may be a specification language that allows a mapping between the external data sources 510 and the model elements.

The ProbIE module 250 comprises multiple interfaces. In the illustrated embodiment, the ProbIE module 250 comprises a query application programming interface 512 (API) and a model API 514. These two interfaces expose the query and model maintenance functions to the external application frameworks 516.

First, the query API 512, such as a “.Net library” or a Web Service 518, operates on the model instance 506 to expose the instance to real-time queries. In the illustrated embodiment, the query API 512 may be used to pull estimated duration information based on PHASE context and EVENT Context information identified as part of the query. The query API 512 may traverse all EVENT nodes and may build an array of the SUMMARY values (computed based on a match with the given EVENT context) and their occurrence probability in a designated portion of a PHASE graph. Each element in the array corresponds to a sub-interval used to define the PHASE. One example may be an array of size one designating a duration time between two time stamp codes, i.e., Begin Time and End Time, for a PHASE defined to represent a single interval. The query API 512 may process single or batch event queries.

Second, the model API 514 such as a “.Net Library” or the web service component 518 may operate on the model schema 504 and the model instances 506 and the ProbIE module 250 configuration 520 settings for programmatic manipulations/maintenance as well as inquiries. In one embodiment, a CHECKER utility may be included to detect redundancies and conflicts in the model schema 504 to keep the model instances 506 in consistent states. Also, various CHECKER related utilities may be included to dump summary values per model in a tabular format for a designated PHASE and EVENT Context (Criteria) to be used for testing the ProbIE module 250 and the model.

Variables MEASURE and CLASSIFICATION may be defined in the duration estimation models. The MEASURE is a dependent variable that represents the durations of interest and the corresponding definitions. The MEASURE may vary per perioperative workflow. The CLASSIFICATION is an independent variable that represents the predictive criteria used to define an EVENT Context. The CLASSIFICATION also may vary per perioperative workflow. One perioperative workflow may rely on multiple duration estimation models. The relationship between the MEASURE and the CLASSIFICATION may be unknown and does not lend itself to an approximation by a linear model. The CLASSIFICATION or predictive criteria employs both continuous (e.g., staffing levels, resource availability) and discrete (categorical) variables (e.g., surgeon, surgical procedure). Because the data necessary to define a practical application may not be available when an estimate is required, the ProbIE module 250 may process incomplete definitions of predictive criteria. The ProbIE module 250 also may track and expose the match strength as it affects the likelihood of predictive criteria. Not all predictive criteria may have the same strength in grouping event data. Accordingly, a prioritization of the predictive criteria through weight assignments may be required.

In the illustrated embodiment, the ProbIE module 250 may be employed to estimate duration of events in a perioperative workflow by incorporating a repository of events from the external data source 510 that are structured around a configurable set of predictive criteria (variables). These repositories may be implemented as the model instances 506 that evolve in time. In other words, the model instances 506 may be re-structured when new event information is introduced to the ProbIE module 250 from the perioperative workflow. The query interface 512 retrieves estimated durations. The queries may comprise incomplete (i.e., partially matching) criteria defining the EVENT Context for the interval of interest. When there is no exact match between the predictive criteria indexing events in the external data source 510 repository and the real-time criteria, the ProbIE module 250 returns the estimate for the best possible match, along with an indicator that represents the likelihood for the duration estimation.

In one embodiment, the ProbIE module 250 may be adapted and configured to implement a regression and classification tree based on flexible model definitions. With categorical data analysis trees, the corresponding models may incorporate criteria that would not perform well in partitioning the historical data consequently affecting the performance and accuracy of the estimations. Accordingly, the ProbIE module 250 may provide feedback mechanisms to test these models in terms of the resulting data distribution at the decision tree leaves to ensure that the variances in the groupings implied by the predictive criteria are not high and do not vary greatly across nodes.

Additionally, the ProbIE module 250 may require the underlying regression tree to evolve and change in structure when necessary as new data is encountered by the interfaced system. The ProbIE module 250, therefore, may incorporate an ongoing process/service that facilitates the event data acquisition and tree re-structuring on a periodic basis.

Finally, the ProbIE module 250 may require a seamless integration with the perioperative workflow external system tracking the events such as the web service component 518 (the PathFinder in the illustrated embodiment) in support of the event data acquisition service. As new predictive criteria can be added to the models dynamically, the data bindings between the external data source 510 database model criteria and the duration/event definitions may be easily extendible. The data mappings may not require additional coding for interfacing with the external system and should preferably accomplished through a binding language.

In one embodiment, the ProbIE module 250 may support various services such as encryption, access privileges for various components, logging, and audit trail utilities.

In operation, one embodiment of the ProbIE module 250 analyzes the operational data in the perioperative workflow to support decisions. Various forms of operational data analysis can underlie the duration estimation for timely initiations and execution of multiple tasks and procedures. The estimations in the perioperative workflow require highly flexible models due to the nature of the criteria necessary to represent the problem context in practical applications.

For example, the interval definitions as well as the intervals of interest can vary based on the perioperative workflow. The conditions driving the estimation, i.e., predictive criteria, based on the perioperative workflow. The facility or site may be a critical factor in predicting interval durations for a multi-facility setting yet may be ignored for others. Perioperative workflow implementations can rely on multiple models varying in their definition or prioritization of the predictive criteria. These models can support different views of those involved in the decision-making process. The relationship between the estimated duration and the predictive criteria is often unknown or does not lend itself to an approximation by a linear model and hence requires a non-linear, non-parametric type of regression fitting approach. The predictive criteria in these estimations make wide use of categorical variables (surgeon, surgical procedure). Hence the estimation process described herein is mostly categorical (discriminant analysis or classification). However, the criteria are not limited to such classifications. For example, staffing levels and resource availability can be represented by continuous variables (nonparametric regression). Such estimations, therefore, require an inference engine such as the ProbIE module 250, the model schema 504, and the model instances 506 that allow for both continuous and discrete (categorical) variables. The data necessary to define a practical application problem context may not be available when an estimate is required. Accordingly, the ProbIE module 250 may be adapted to process an incomplete definition of predictive criteria for the perioperative workflow duration estimations. Furthermore, the ProbIE module 250 can track and expose the match strength as it affects the likelihood of the estimate (probability coefficient). Not all predictive criteria have the same strength in grouping event data, requiring a prioritization of the predictive criteria through weight assignments. Such prioritization could in turn affect the decision tree structuring and the likelihood or (probability coefficient) during retrieval. These weights may be re-adjusted through a feedback mechanism that involves the analysis of event distributions at the decision tree leaves.

To address these and other ProbIE module 250 requirements discussed herein, the ProbIE module 250 may comprise a core regression and classification algorithm, i.e., the ProbIS module 502 in the illustrated embodiment. The core module may be primarily adapted to implement a flexible and dynamic representation of predictive criteria which do not lend themselves to fixed schemas (e.g., use of fixed object or relational data models). Rather, the ProbIS module 502 comprises models represented via decision and regression forests that can grow and get re-structured when new information is added to the system 500.

The ProbIS module 502 also may be adapted by the manner in which the predictive criteria are prioritized. In other words, the structuring of the tree, i.e., ordering of intermediary nodes and pruning, can potentially rely on the suggested prioritization. The model development process hence may be a declarative one and may require explicit weight adjustments in case the predictive model has poor accuracy.

In addition, the ProbIS module 502 may be shaped by the need for scalability. Accordingly, in one embodiment the model schemas 504 and the model instances 506 may be scaled up to queries with incomplete criteria, necessitating summarized and/or generalized predictions at the intermediary nodes as opposed to a full match between an event at the leaf and the current event context. Such predictions may be assigned a likelihood coefficient depending on their position in the tree.

Various regression and classification tree/forest algorithms may be available for implementation. Most regression and classification tree/forest algorithms introduce random sampling in terms of event data as well as predictive criteria to build the suggested forests for better performing predictive models (e.g., DTReg). The ProbIE module 250 may require predictive variable definition and prioritization to guide the tree structuring. The ProbIE module 250 provides improved predictive models, in terms of their accuracy, via an interactive process involving the generation and testing of various model instances ongoing basis. The modeler who creates and maintains the ProbIE module 250 models has domain knowledge of the perioperative workflow and is able to identify and prioritize the critical predictive variables.

Additionally, various conventional regression and classification algorithms require linear models at the tree leaves for improved accuracy of the predictions (e.g., CART, Breiman). The ProbIE module 250, on the other hand, provides duration estimations at the intermediary nodes of the decision tree aggregated/generalized from the children nodes to accommodate queries with incomplete criteria to support scalability. Note that the distribution of data at these intermediary nodes may be poor (high variance, no central tendency). The state of the data distribution should be considered in the computation of a likelihood (probability) coefficient in the ProbIE module 250.

In one embodiment, the ProbIE module 250 queries specific tree traversals as it supports real-time decision support. On the other hand, the tree (re)-structuring (updates and insertions) may take place as part of periodical updates processed in batches on the back end. Accordingly, the choice of data structures may facilitate heavy indexing and structuring for efficient retrieval and require longer time for updates and insertions.

In operation, the ProbIE module 250 enables real-time decision making that relies on historical data. The historical data may comprise the duration for an event performed by an individual at some time during the day. For example, the historical data may comprise information such as how long it takes on average for a surgeon X to perform a procedure Y as the first case of the day. If there is no match for the actual case of interest and the cases stored in the external data sources 510, the ProbIE module 250 may retrieve information associated with other procedures performed by the individual at the same time of day. For example, if the surgeon X never performed the procedure Y, the ProbIE module 250 may query the external data source 510 for an average duration of other procedures that the surgeon X performed in the past as the first case of the day.

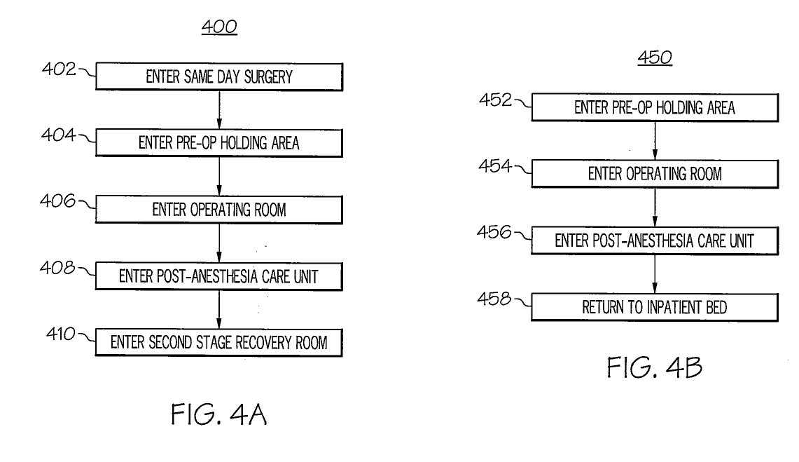

FIG. 4A is a diagram 400 illustrating the stages of one embodiment of the perioperative workflow process 210 for an ambulatory patient 208. An ambulatory 208 patient enters same-day surgery 402. The patient 208 then may enter a pre-op holding area 404. The patient 208 then enters the operating room 406, followed by a post-anesthesia care unit 408 and a second-stage recovery room 410. Optionally, the patient 208 may proceed from the operating room to an intensive care unit 412.

FIG. 4B is a diagram 450 illustrating the stages of one embodiment of the perioperative workflow process 210 for an inpatient 208. An inpatient 208 may enter a pre-op holding area 452. The patient 208 then enters the operating room 454, followed by a post-anesthesia care unit 456. Following the post-anesthesia care unit, the patient 208 returns to an inpatient bed 458.

In various embodiments, the patient workflow process system 100 and/or the perioperative system 200 may be illustrated and described as comprising several separate functional elements, such as modules. Although certain modules may be described by way of example, it can be appreciated that more or fewer modules may be used and still fall within the scope of the embodiments. Further, although various embodiments may be described in terms of modules to facilitate description, such modules may be implemented by one or more hardware components (e.g., processors, DSPs, PLDs, ASICs, circuits, registers), software components (e.g., programs, subroutines, logic, application components), and/or combinations thereof.

The modules may comprise, or may be implemented as, one or more systems, sub-systems, devices, components, circuits, logic, programs, or any combinations thereof, as desired for a given set of design or performance constraints. For example, the modules may comprise electronic elements fabricated on a substrate. In various implementations, the electronic elements may be fabricated using silicon-based integrated circuit processes, such as, for example, complementary metal oxide semiconductor (CMOS), bipolar, and bipolar CMOS (BiCMOS) processes. The embodiments are not limited in this context.

Numerous specific details of the RTLS 206 and correction module 270 therefor have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application-specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operation in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory module. For example, the memory module may include any memory device, memory article, memory medium, storage device, storage article, storage medium and/or storage module, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and variations, as well as any other applicable technologies which may appear in the future, as falling within the true scope of the embodiments.

What is claimed is:

1. A method, comprising:
predicting a duration for at least one event of a perioperative workflow using one or more models, wherein each of the one or more models includes at least one model instance;
querying the at least one model instance; and
generating the predicted duration responsive to the query.

2. The method of claim 1, comprising defining the one or more models.

3. The method of claim 2, comprising:
for each of the one or more models, identifying one or more predictive criterion based on the perioperative workflow; and
prioritizing the identified criterion by weight assignments.

4. The method of claim 3, comprising:
identifying one or more of a discrete predictive criterion and a continuous predictive criterion.

5. The method of claim 4, wherein the discrete predictive criterion is selected from the group consisting of:
a health care facility;
a type of perioperative workflow;
a type of perioperative workflow event; and
an identity of one or more individuals associated with the perioperative workflow.

6. The method of claim 4, wherein the continuous predictive criterion is selected from the group consisting of:
a staffing level; and
a resource availability.

7. The method of claim 3, comprising:
defining one or more of a regression tree model and a classification tree model based on historical perioperative workflow data and the one or more predictive criterion.

8. The method of claim 2, comprising:
training each of the one more models.

9. The method of claim 3, comprising:
querying the at least one model instance using one or more query criterion partially matching the one or more predictive criterion; and
generating a likelihood indication of the predicted duration.

10. A system, comprising:
an inference engine for predicting a duration for at least one event of a perioperative workflow using one or more models, wherein each of the one or more models includes at least one model instance; and
a query interface for querying the at least one model instance;
wherein the inference engine generates the predicted duration responsive to the query;

11. The system of claim 10, comprising a model interface to:
programmatically manipulate the one or more models and a model schema corresponding to each of the one more models; and
configure one or more settings of the inference engine.

12. The system of claim 10, wherein each of the one more models comprises one or more predictive criterion based on the perioperative workflow.

13. The system of claim 12, wherein the one or more predictive criterion for each of the one more models are prioritized by weight assignments.

14. The system of claim 12, wherein the one or more predictive criterion comprise:
one or more of a discrete predictive criterion and a continuous predictive criterion.

15. The system of claim 14, wherein the discrete predictive criterion is selected from the group consisting of:
a health care facility;
a type of perioperative workflow;
a type of perioperative workflow event; and
an identity of one or more individuals associated with the perioperative workflow.

16. The system of claim 14, wherein the continuous predictive criterion is selected from the group consisting of:
a staffing level; and
a resource availability.

17. The system of claim 12, wherein each of the one or more models comprises:
one of a regression tree model and a classification tree model, wherein the model is based on historical perioperative workflow data and the one or more predictive criterion.

18. The system of claim 10, comprising a training module for training the one or more models.

19. The system of claim 12, wherein the inference engine is configured to:
query the at least one model instance using one or more query criterion partially matching the one or more predictive criterion; and
generate a likelihood indication of the predicted duration.
